(19) United States
(12) Patent Application Publication
(10) Pub. No.: US 2010/0009168 A1
(43) Pub. Date: Jan. 14, 2010

(54) COATED PAPER OR BOARD PRODUCT AND PROCESS FOR THE PREPARATION THEREOF

(75) Inventors: Jaakko Raukola, Tampere (FI); Soili Peltonen, Vtt (FI); Hannu Mikkonen, Vtt (FI); Pia Qvintus-Leino, Vtt (FI)

Correspondence Address: SUGHRUE MION, PLLC, 2100 PENNSYLVANIA AVENUE, N.W., SUITE 800, WASHINGTON, DC, 20037, US

(73) Assignee: Vuorimiehentie 3, Espoo (FI)

(21) Appl. No.: 12/442,839

(22) PCT Filed: Sep. 24, 2007
(86) PCT No.: PCT/FI07/50504

§ 371 Date: May 20, 2009

(30) Foreign Application Priority Data
Sep. 25, 2006 (FI) 20065587

(51) Int. Cl. B32B 5/16; B32B 21/06; B32B 27/10; B05D 1/36; B05D 3/12; B05D 3/06

(52) U.S. Cl. 428/326; 428/533; 428/513; 428/323; 428/342; 427/411; 427/322; 427/569

(57) ABSTRACT

A coated paper or board product and a method of manufacturing the same. The product comprises a base layer made of paper or board, with at least one coating layer containing at least one polysaccharide-based pigment, and at least one polymer layer being spread on top of it. The invention can considerably improve the adhesion of the coating and the polymer layer.

The present invention relates to the coated paper or board product according to the preamble of Claim 1.

Generally, such a product comprises a coated base track, at least one surface thereof comprising a film of thermoplastic material.

The invention also relates to a means of improving the adhesion between a fibre substrate and a plastic film according to the preamble of Claim 23, and a method of manufacturing a coated paper or board product according to the preamble of Claim 25.

The most common problem with the extrusion coating of, for example, kaolin-coated, especially clay-coated paper and board products is the poor adhesion of molten plastic to the kaolin or clay coating. In particular, the problem has been observed with liquid packaging boards, wherein the inadequate adhesion causes peeling of the plastic coat and, thus, problems with seaming and folding, and in the final products, leakage of the contents or the gas that protects the contents. It is known to improve the adhesion by an electric corona pre-treatment and flame pre-treatment, of which the latter, in particular, has proven to be a method that improves the adhesion of clay coatings. One disadvantage of the flame treatment is the dangerous situations caused by it in connection with the processing. Generally, separate prime coatings are used for clay surfaces, improving the adhesion considerably. However, this causes an extra stage of treatment, increases the costs of raw materials and the basis weight of the end product.

Improvement of adhesion has been studied extensively, and it is common knowledge that the adhesion of kaolin and CaCO₃ to polymers is poor and, thus, providing a good adhesion between the thermoplastic film and the clay coating is quite a generic problem.

The object of the present invention is to eliminate at least some problems of the prior art and to provide a novel laminated product, wherein the thermoplastic film is attached to the substrate consisting of coated paper or board in a more reliable manner than before.

The invention is based on the idea that a sufficient amount of polysaccharide-based particles are incorporated into the interface between the substrate layer consisting of fibre material and the plastic film. Namely, we have surprisingly discovered that polysaccharide particles, such as starch pigments, have extremely good adhesion to plastic films that typically consist of hydrophobic materials. When the coated paper or board substrate contains at least about 5%, particularly at least about 10% of polysaccharide pigment from the weight of the coating layer, the adhesion of the plastic film to the surface of the substrate is reliable.

According to the invention, a solution is thus obtained for improving the adhesion between the substrate, especially a fibre substrate, and the plastic film covering the same, wherein polysaccharide particles are brought to the interface between the substrate and the plastic film, the particles being able to improve the adhesion between the substrate and the plastic film. Accordingly, the product according typically comprises a base layer manufactured of paper or board, a polymer layer having been attached to the surface thereof, whereby the surface of the base layer facing the polymer film contains polysaccharide-based particles for improving the adhesion between the base layer and the polymer layer.

The product can be manufactured by applying a coating layer on the surface of the paper or board layer, containing at least one polysaccharide-based pigment, after which the coating layer is optionally treated, for example, by heat or pressure to at least partially plasticize the pigment. Thereafter, at least one polymer layer in the form of, e.g., a thermoplastic film is spread on the coating layer. The pigment particles can also be incorporated into the surface of the paper or board layer in the form of a filling agent or by dry coating.

To be more precise, the paper or board product according to the present invention is characterized by what is stated in the characterizing part of Claim 1.

The means according to the invention, in turn, is characterized by what is stated in the characterizing part of Claim 23, and the method is characterized by what is stated in the characterizing part of Claim 25.

The present invention provides considerable advantages. Accordingly, the adhesion between the substrate and the plastic film can be considerably improved, whereby the present problems of seaming and folding laminated products can be decreased or even fully eliminated. The need for corona or primer treatments can be reduced; the products can also be manufactured without them on a case-specific basis. By using the present polysaccharide particles, the mineral filling or coating agents of the paper can at the same time be at least partially replaced with renewable materials of a natural origin without weakening the properties important to the end use of the paper, such as strength, brightness or opacity. At the same time, paper with a lighter basis weight is obtained, whereby the logistic costs are decreased and more printing surface with the same mass is obtained. The filling or coating agents of a natural origin, i.e., organic agents, also eliminate problems with respect to the ashes generated in burning the paper and the final treatment of de-inking the sludge.

In the following, the invention is examined in detail with the aid of a specification and with reference to the appended drawings, whereby

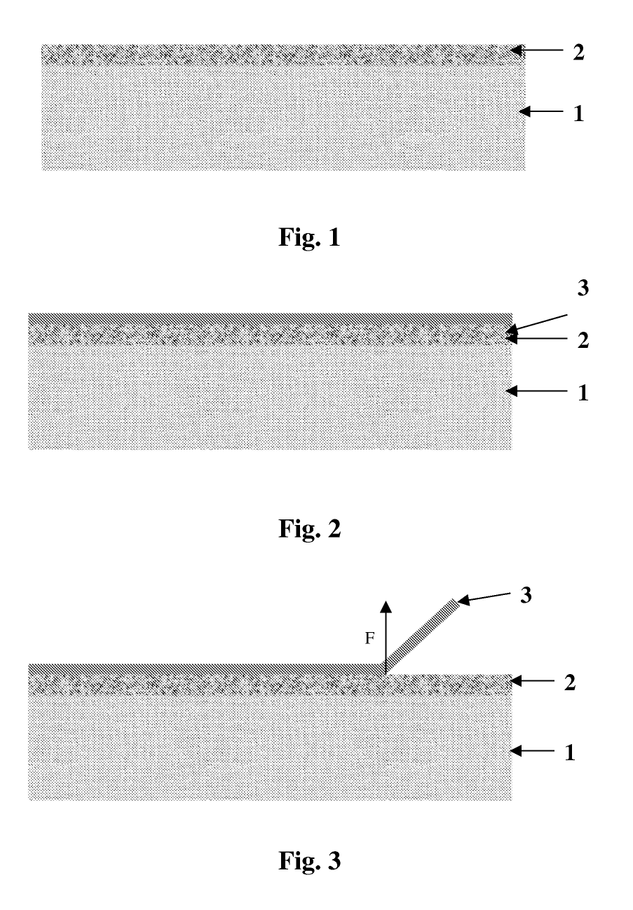

FIG. 1 is a schematic cross section of a paper or board track coated with a layer of polysaccharide,

FIG. 2 is a schematic cross section of the paper or board track coated with a polymer layer and a layer of polysaccharide pigment,

FIG. 3 is a schematic cross section of the paper or board track coated with the polymer layer and the layer of polysaccharide pigment, whereon force F is exerted to peel the polymer layer off the polysaccharide layer, and

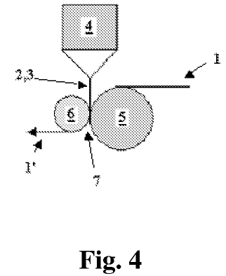

FIG. 4 is a schematic side view of extrusion coating.

As stated above, the product according to the invention comprises a base layer made of paper or board and a polymer layer, which is spread on at least one surface of the base layer, whereby the surface of the base layer facing the polymer film contains polysaccharide-based particles to improve the adhesion between the base layer and the polymer layer. The polymer layer consists of a thermoplastic film, in particular. The polysaccharide-based particles, in turn, can be incorporated as pigments into the coating layer that covers the surface of the base layer, whereby the polymer layer is applied on top of the coating layer. Alternatively, they can be incorporated into the base layer as filling agents. The coating can be performed by conventional methods or dry coating.

The basic solution of the structure according to the invention is also presented in FIGS. 1 to 3, the layers in the products according to the same being given the following reference numbers:
1 Base layer made of paper or board
2 Organic coating layer
3 Polymer layer

The paper machine according to FIG. 4 includes the following parts for extrusion coating:
4 Extruder
5 Chill roll
6 Press roll
7 Nip

The “first coating layer” in this invention refers to a layer comprising a polysaccharide-based pigment. Coating layer 2 may consists of one or more partial layers. The “second coating layer” 3 refers to the polymer layer or the plastic coating layer, which preferably comprises heat-setting plastic, such as polyethylene.

FIGS. 1 to 3 illustrate the manufacture of the product by a conventional coating technique and a subsequent extrusion coating. At least one coating layer 2 containing at least one polysaccharide-based pigment, and at least one polymer layer 3 are spread on the surface of the base layer 1 manufactured of paper or board. Either layer may constitute the outer, i.e., the topmost layer of the product. According to a preferred embodiment, the polymer layer 3 constitutes the topmost layer in the figure. In that case, at least one coating layer 2 is first spread on the surface of the base layer 1 manufactured of paper or board, containing the polysaccharide-based pigment and, optionally, one or more other, typically mineral pigments, at least one binding agent, and optional additives that are generally used in coatings in the paper and board industry. The coating mix containing polysaccharide particles can be used both in the pre-coating and the front coat. Accordingly, the paper or board product coated with the polysaccharide pigment layer 2 can also be coated with another organic partial coating layer that contains at least some polysaccharide pigment, at least one binding agent and the optional additives generally used in coatings in the paper or board industry.

The polymer layer 3, which preferably consists of a thermoplastic-type polymer, suitably polyolefin, such as polyethylene or polypropylene, is added by feeding molten polymer from the extruder 4 on top of the paper or board track 1 that is provided with the first organic coating layer 2.

According to FIG. 4, the track 1 is thereafter fed through the nip 7 between the chill roll 5 and the press roll 6, whereby an extrusion-coated paper or board product 1′ is obtained. If the product is used for the manufacture of packing boards, it is generally enough that one of the board's surfaces has the required properties, such as barrier properties. In this case, the coating layer and the plastic layer are brought to one surface of the base layer only. However, according to the invention, it is possible and often preferable to spread the coating layer on both surfaces of the base layer and to provide them with a plastic cover.

Surprisingly, we have discovered that the coating layer containing polysaccharide pigment also improves the adhesion, even if it does not form a uniform layer on the surface of the substrate. Therefore, this coating mix can also be spread on certain places of the surface of the product only, whereby point adhesion is provided. In this application, about 40 to 99.9%, preferably about 50 to 99.9%, especially preferably about 60 to 90% of the product's surface is covered with the polysaccharide pigment-containing coating layer.

The printing that is optionally added to the product can either be placed under the coating layers, between them or on top of them. If the printing was made between two plastic layers, the adhesion between them would deteriorate, but if, according to the present invention, the printing is made between the coating layer containing polysaccharide particles and the polymer layer (i.e., on top of the coating layer), this will not essentially weaken the adhesion.

The present invention provides coated paper or board having good strength properties, its filling and/or coating agents having partially or fully been replaced with renewable materials of a natural origin. When the first coating layer comprises the polysaccharide-based pigment, the adhesion of the second coating layer in the extrusion coating can be improved considerably. The polysaccharide-based pigment strongly adheres to the polymer coating layer in addition to strongly adhering to the fibres of the base layer.

The “polysaccharide-based coating” in the present invention refers to a coating layer that is spread on the paper or board product and comprises, as fine particles, a typically conventional pigment, such as kaolin, calcium carbonate or talc, and a polysaccharide-based pigment, such as starch, a derivative of the starch, cellulose or a derivative of the cellulose. Generally, the portion of polysaccharide pigments may be about 5 to 100% by weight from the dry matter of the layer. Typically, the particle size of the fine particles of the coating is about 25 μm at the most, preferably about 0.5 to 25 μm, most preferably about 0.5 to 10 μm.

The term “polysaccharide-based pigment” (or “organic pigment”) is used to determine a pigment of a natural origin. These include, among others, cellulose-based pigments, such as cellulose and the derivatives of cellulose, and starch-based pigments, such as starches and starch derivatives.

The present invention employs a polysaccharide-based pigment, such as cellulose pigment or starch pigment. The starch particles may be porous (e.g., coral-like) or spherical. In particular, the spherical particles are used as pigments, and the porous/coral-like particles as fillers.

The term “spherical particle” refers to an essentially ball-shaped particle with a size of about 100 to 1000 nm, preferably about 100 to 500 nm. The definition also includes ellipsoid-shaped particles. The term “coral-like particle” refers to a porous or nanoporous particle with a size of about 1 to 100 microns, containing pores with an average size of about 100 to 500 nm.

The optical properties of the particles, the spherical ones in particular, are good—their ISO brightness is typically over 80. The ISO brightness of the spherical products, in particular, may be as high as 92 to 96, and that of the porous ones at least 80, preferably at least 82, most preferably at least 84.

Starch-based polymers have a natural tendency to good adhesion both to fibre-based materials and plastics, and even to oil-based processed products. The starch pigment can also be modified to the purpose so as to considerably improve its adhesion to polyethylene, which is mainly used in extrusion-coated products.

In terms of structure, the starch pigment also improves the bonding strength compared to, e.g., mineral pigment-based coatings, particularly because of its good binding properties.

According to the invention, the coating layer does not have to consist of the polysaccharide coating only, but according to a preferred embodiment, the pigment of the conventional coating, such as kaolin or CaCO₃, is only partially replaced. Generally, 1 to 80% by weight of the amount of pigment comprises the conventional pigment, preferably 20 to 80% by weight, more preferably 30 to 70% by weight, most preferably about 50% by weight.

According to another preferred embodiment, part of the filler used in the manufacture of the base layer is replaced with the organic component according to the invention, such as the polysaccharide component. Preferably, about 15 to 90% by weight, more preferably about 25 to 75% by weight, most preferably about 25 to 65% by weight of the filler are replaced.

According to another preferred embodiment, the polysaccharide pigment is used in forming quite a thin surface layer, preferably with a thickness of 0.5 to 10 g/m², more preferably 1 to 8 g/m², on the surface of the product.

The pigments used in the invention are manufactured, for example, by dissolving a starch-based component in a solvent, from where it is precipitated by bringing the solution in contact with a precipitant. The solvent is removed, for example, by evaporation from the dispersion obtained from the precipitation stage, after which the precipitate is separated from the precipitant and recovered.

In the manufacture of pigments, the starch-based component that is used as the initial material is preferably a “functional” starch derivative. This refers to a product obtained from the starch by a chemical reaction, at least part of its anhydroglucose units including groups that modify hydroxyl functions.

The starch derivative is especially preferably based on products that are manufactured from natural starches by oxidizing, hydrolyzing, cross-linking, cationizing, grafting, etherifying or esterifying.

The starch component is preferably a hydroxyalkylated starch or its ester, a starch alkenyl succinate including a linear or branched alkenyl group, or a starch-based component, which originates in the ester formed by the starch and one or more aliphatic C₂₋₂₄ carboxylic acids. In that case, the carboxylic acid component of such an ester can be derived from a lower alkane acid, such as acetic acid, propionic acid or butyric acid, or a mixture thereof. However, the carboxylic acid component can also be derived from a natural saturated or unsaturated fatty acid. Examples of these, worth mentioning, include palmitinic acid, stearic acid, oleic acid, linolic acid, and the mixtures thereof. The ester can also consist of both long-chain and short-chain carboxylic acid components. As an example, the mixed ester of acetate and stearate could be mentioned. To form the ester, in addition to acids, corresponding acid anhydrides and acid chlorides, as well as other corresponding reactive acid derivatives can also be used in a known manner.

Two kinds of pigments can be produced, namely a product comprising spherical particles and a nanoporous product that is characterized as “coral-like”. Both are manufactured by bringing the solution of the starch derivative in contact with the precipitant. In that case, the precipitant is a substance, which is capable of precipitating the starch derivative in the solution as perfectly as possible, when its amount in the liquid system is large enough. Generally, at least 70% by weight, preferably at least 80% by weight, and especially preferably 90% by weight, even as much as 95% by weight of the starch derivative in the solution are precipitated. According to the solvent or solvent mixture, the amount of precipitant is generally 0.1 . . . 100-fold, preferably about 0.5 . . . 10-fold, most preferably about 0.7 . . . 5-fold in relation to the amount of solvent or solvent mixture (as calculated on the basis of the weight).

The pigments of the invention are preferably manufactured by using the manufacturing methods described in Finnish patent applications 20040741, 20040743, and 20050833.

The spherical particles with a particle size (the average diameter size) of 90 to 1000 nm, preferably less than about 500 nm, more preferably less than 400 nm, most preferably less than 350 nm, are formed spontaneously, when the starch solution is diluted with water or a corresponding precipitant.

The polysaccharide pigment can be added to the conventional coating, or one or more surface coating layers containing the polysaccharide pigment can be added on top of the pre-coating. If only one coating layer containing the polysaccharide pigment is applied on the surface, the amount of the coating composition used is preferably about 10 to 40 g/m², preferably about 20 to 35 g/m². If at least two coating layers are applied, the amount or the thickness of the pre-coating or the surface coating or both can be reduced so that the amount mentioned above becomes the total amount of the coating compositions used. In that case, the amount of pre-coating is, e.g., about 1 to 20 g/m², preferably about 5 to 15 g/m², most preferably about 7 to 10 g/m². The amount of coating in the topmost layer is about 5 to 35 g/m², preferably about 10 to 30 g/m², most preferably about 20 to 30 g/m².

The layer thickness of the pigment coating is preferably about 5 to 40 μm, preferably about 5 to 35 μm.

According to one preferred embodiment, the pigment of the organic coating layer comprises the polysaccharide-based pigment. As in conventional coating manufacturing methods, the polysaccharide component in the coating manufacture according to this embodiment is mixed with a binder, an optional second binder, and optional additives.

Generally, 5 to 100% by weight of the filler of the base layer or the pigment of the base layer's coating layer consists of polysaccharide-based particles. In addition to the polysaccharide-based pigment particles, the coating layer most preferably contains mineral pigments, such as kaolin, calcium carbonate, talc, gypsum, or a mixture thereof. In that case, the coating layer contains 5 to 50 weight fractions of polysaccharide-based particles and 50 to 95 weight fractions of mineral pigments.

As the binder of both the pre-coating and the surface coating, e.g., latex, starch-based binder, water-soluble polymer or polyvinyl alcohol, preferably latex or a mixture thereof can be used, its amount being about 1 to 20% by weight of the pigment, preferably about 5 to 15% by weight, most preferably about 10% by weight. As below, the starch-based binder can be/originate in a starch ester, starch ether, mixed ester/ether of starch, or grafted starch, which is manufactured from a derivative of the starch, such as native starch, hydrolyzed starch, oxidized starch, cross-linked starch or gelatinized starch. The starch-based binders are preferable, especially those based on native starch, because being natural substances, they are completely recyclable.

The optional second binder used in the present invention can be carboxymethyl cellulose (CMC) or hydroxyethyl cellulose, preferably carboxymethyl cellulose, its amount as calculated from the pigment being 2% by weight at the most, preferably 0.1 to 1.5% by weight, and most preferably 0.1 to 1% by weight.

The optional additives and auxiliary substances can be, among others, dispersants (e.g., the sodium salt of polyacrylic acid), substances that affect the viscosity and the water retention of the mixture (e.g., CMC, hydroxyethyl cellulose, polyacrylates, alginates, benzoate), so-called lubricants, hardeners that are used to improve the water resistance, optical auxiliaries, anti-foam agents, pH adjusters, and anti-deterioration agents. Some lubricants worth mentioning are sulphonated oils, esters, amines, calcium or ammonium stearates; some substances improving the water resistance include glyoxal; some optical auxiliaries include the derivatives of diamino stillbene disulphonic acid; some anti-foam agents include phosphate esters, silicones, alcohols, ethers, vegetable oils; some pH adjusters include sodium hydroxide, ammonium, sulphuric acid, acetic acid, and sulphonic acids; and, finally, some anti-deterioration agents include formaldehyde, phenols, quartemary ammonium salts. The total amount of additives and auxiliary substances in the composition, as counted from the pigment, is 10% by weight at the most, preferably 0.1 to 5% by weight, and most preferably 0.1 to 2% by weight.

Water is added to the coating composition so that its total dry matter content is preferably 40 to 60%, most preferably about 50%.

The composition of a typical pigment coating according to this embodiment is as follows:

| | |
|---|---|
| Coating pigment | 100 weight fractions |
| Binder | 1 to 20% by weight from the pigment |
| Second binder | 0.1 to 2% by weight from the pigment |
| Additives and auxiliaries | 0.1 to 10% by weight from the pigment |
| Water | the rest |

According to another preferred embodiment, the pigment of the coating composition comprises a mixture of polysaccharide-based pigment and conventional pigment. The binders and additives and their amounts are the same as in the previous embodiment. The conventional pigment is, e.g., kaolin, CaCO₃ or talc, and its amount is 1 to 80% by weight, preferably 20 to 80% by weight, more preferably 30 to 70% by weight, most preferably about 50% by weight as calculated from the total amount of pigment.

Water is added to the coating composition so that its dry matter content is preferably 40 to 60%, more preferably about 50%.

The composition of a typical pigment coating according to this second embodiment is as follows:

| | |
|---|---|
| Polysaccharide-based coating | 20 to 99 weight fractions |
| pigment | |
| Conventional coating pigment | 1 to 80 weight fractions |
| Binder | 1 to 20% by weight from the pigment |
| Second binder | 0.1 to 2% by weight from the pigment |
| Additives and auxiliaries | 0.1 to 10% by weight from the pigment |
| Water | the rest |

In dry coating, a suitable amount, e.g., about 0.1 to 10 g/m² of polysaccharide-based particles are applied by dry coating on top of the base track or the coated base track.

A polymer film is thereafter spread on top of the coated substrate or the one containing polysaccharide as filling agent according to the invention. However, before this stage, the substrate can be treated to at least partially plasticize the polysaccharide-based particles, when so desired. The treatment may include calendering the base layer and, possibly, bringing it to the conventional corona treatment before applying the polymer film. However, the solution according to the invention reduces the meaning of the corona treatment in providing good adhesion between the substrate and the plastic film, as stated above.

The polymer layer according to the invention is preferably added on top of the paper or board product by extrusion coating. Extrusion is a process, wherein the material to be moulded is formed from a homogeneous substance, preferably thermoplastic polymer (often in the form of pellets or powder) having a high viscosity, high molecular weight and high melting point, optionally with additives, by pressing it through a nozzle by means of pressure. In this way, the extruded material acquires the shape determined by the nozzle and it drifts through the nozzle as a homogeneous, uniform, and wide band. This material band is then pressed into a thin film on the surface of a quickly moving paper or board track. The track is fed through the nip between the chill roll and the press roll, while the film is still in the molten state.

The pressure caused by the nip makes the coating material to partially plasticize, whereby a stronger adhesion is provided between the coating and the substrate. The distance between the nozzle and the nip also affects the adhesion. A great distance improves the adhesion but, at the same time, it may cause an excessive chilling of the film, whereby the plasticizing becomes weaker. The solidifying of the film will not happen until under the effect of the chill roll, i.e., after passing through the nip. The material and the temperature of the chill roll affect many, among others, the optical properties, but the press roll has a greater effect on the strength of the adhesion. The pressure at the nip between the press roll and the chill roll is generally about 10 to 30 kN/m.

Typically, the thickness of the coating made by extrusion is about 10 to 200 μm, preferably about 30 to 100 μm. The mass of the coating is typically 10 to 100 g/m², preferably 20 to 50 g/m².

According to a preferred embodiment of the present invention, the polymer used in the polymer layer is any polymer generally used in the extrusion process. These include polyethylenes, polypropylenes, ethyl vinyl acetate, ethyl butyl acrylate, ethyl methyl acrylate, ethyl ethyl acrylate, acid copolymers, modified polyolefins, ethyl vinyl alcohol, polymethyl pentane and different polyamides and polyesters.

Polyethylene is most preferably used in the polymer coating of the present invention. The advantages of polyethylene in the coating include its good moisture barrier properties, good seaming properties, good thermal resistance, combustibility, user-friendliness, purity, inertness, lack of smell and taste, transparency, and low price. There are three different density categories for polyethylene (low density, LD, medium density, MD, and high density, HD, polyethylene, PE), of which the low density polyethylene is the polymer most commonly used in extrusion coating. The polyethylene may be linear, such as LLDPE (linear low density polyethylene).

Polypropylene is also well-suited to be used in the polymer coating according to the present invention. Polypropylene is used in extrusion coating mainly because of its thermal and fat resistances. Polypropylene homopolymer withstands temperatures of 105° C. for long periods of time, and those of 120 to 130° C. for shorter periods. When needed, the properties of polypropylene can be modified by polyethylene modification.

The advantages of copolymers, such as ethyl vinyl acetate, ethyl butyl acrylate, ethyl methyl acrylate, and ethyl ethyl acrylate in extrusion coating include their flexibility. Therefore, they are not used that often in board packages. However, because of their adhesion abilities, they can also be advantageous in the products of the present invention.

Acid copolymers and modified polyolefins can also be used in the polymer layer to provide good adhesion either between the base layer and the polymer layer or between the polysaccharide layer and the polymer layer. If the polymer layer is placed between the base layer and the polysaccharide layer, the polymer layer in question thus improves the adhesion to both the base layer and the polysaccharide layer. Acid copolymers and modified polyolefins can preferably also be used separately as adhesives between the various layers.

In the present invention, ethyl vinyl alcohol and polyamides are preferably used to provide or improve different barrier properties. The copolymers of ethyl vinyl alcohol provide extremely good gas and aroma barrier properties. The adhesion and the thermal resistance are also good. Polyamides, in turn, withstand high temperatures well and also work as a gas barrier in the product.

The final total weight of the coated paper or board according to the present invention is about 50 to 500 g/m², preferably about 50 to 450 g/m², especially preferably about 60 to 400 g/m², and its total thickness, respectively, is about 50 to 500 μm, preferably about 50 to 450 μm, and especially preferably about 60 to 400 μm, of which about 60 to 95% by weight, preferably about 70 to 95% by weight, and especially preferably about 75 to 95% by weight comprises the base layer of the paper or board product.

The adhesion between the plastic coating and the pigment coating of paper/board improves, when:
only polysaccharide-based pigment is used in the pigment coating,
polysaccharide-based pigment is used in the pigment coating in addition to other pigments, or
organic pigment is used in the pigment coating, and
the polymer is attached in a molten stage by, for example, the extrusion or hot-roll methods, and
the pigment coating containing polysaccharide-based pigment is pre-corona treated or flame-treated before coating with the plastic film.

Among others, the product according to the present invention is extremely well-suited to packing material, e.g., for food products, household products, and medicinal and other hospital products. The polymeric layer gives the product good barrier properties, whereby liquids, aromas, gases and vapours, among others, are caused to either stay inside the packaging product or outside the product. The product is also well-suited to recycling, as the polysaccharide pigment is a biodegradable material and the plastic coating is easy to peel off the product in connection with pulping despite the fact that the layer remains tightly attached to the product in connection with the use. Furthermore, polyethylene being combustible, the entire product can be burned, when so desired.

In the following, the invention is examined in detail with the aid of a few non-limiting application examples.

### EXAMPLE 1

To coat paper, a coating composition was prepared, consisting of 75 portions of kaolin, 25 portions of starch pigment (manufactured according to patent application FI 20035173), 10 portions of latex, 1 portion of thickener, and 0.2 portions of dispersant. A reference composition was prepared so that only kaolin was used as the pigment (100 portions) and the amount of other components was kept the same. The dry matter portion of the coating composition was 50% and its viscosity 800 cps. The paper was coated with both compositions so that the amount of coating was 7 g/m², and calendered with a pressure of 1850 PLI at a temperature of 300° F.

Polyethylene (Borealis PE-LD, CA 7230, MFI 14.5 g/10 min) was applied on both coated papers by extrusion coating (FIG. 4), whereby structures similar to FIG. 2 were provided.

The temperature of the polymer in the coating was 300° C. and the line speed of the track 110 m/min. The nip pressures were the same in both coatings, and so was the corona treatment (3 kW). The amount of coating was about 25 g/m².

The adhesion of the polyethylene coat to the surface of the paper coated with the coating comprising starch pigment was clearly better than its adhesion to the coating comprising only kaolin as the pigment. The plastic coating came off the kaolin coat unbroken, whereas it was impossible to remove it in one piece from the coating comprising starch pigment.

### EXAMPLE 2

Basic compositions were prepared from starch pigment and kaolin:

| | Composition 1 | Composition 2 |
|---|---|---|
| Substance | Portion | Portion |
| Starch pigment | 100 | — |
| Kaolin | — | 100 |
| Latex | 12 | 12 |
| CMC | 1.2 | 1.2 |

The paper coated with the compositions was dried and each paper was calendered at the same pressure at 80° C.

Polyethylene was applied on the coated paper, as in Example 1. The polyethylene adhered to the paper coated with the composition comprising starch pigment clearly better than to the paper coated with the kaolin composition. The polyethylene came off the surface of the kaolin coat as an unbroken, albeit stretched film, but it was impossible to remove the film from the starch pigment surface. The force F is thus greater in the method according to the present invention than when removing from the coat not containing polysaccharide pigment or polymer (FIG. 3).

1. A product comprising
a base layer (1) manufactured of paper or board, and
a polymer layer (3), which is spread on at least one surface of the base layer (1), characterized in that
the surface of the base layer (1) facing the polymer film (3) contains polysaccharide-based particles to improve the adhesion between the base layer (1) and the polymer layer (3), which polysaccharide-based particles are spread on the surface of the base layer (1) or the coating layer covering it.

2. A product according to claim 1, characterized in that the polysaccharide-based particles are incorporated as pigments into the coating layer (2) that covers the surface of the base layer, whereby the polymer layer is applied on top of the coating layer.

3. A product according to claim 1, characterized in that the polysaccharide-based particles are incorporated into the base layer as a filling agent.

4. A product according to claim 1, characterized in that the polymer layer (3) contains thermosetting plastic.

5. A product according to claim 4, characterized in that the polymer layer (3) contains polyolefins, copolymers of olefins, vinyl carboxylates or thermoplastic elastomers.

6. A product according to claim 5, characterized in that the polymer layer (3) consists of a polyolefin film, especially a polyethylene or polypropylene film or a film formed by the copolymers of olefins, which is spread on the base layer by extrusion.

7. A product according to claim 1, characterized in that there is a polymer layer (3) provided on both surfaces of the base layer (1).

8. A product according to claim 1, characterized in that the polysaccharide-based particles are starch or cellulose-based.

9. A product according to claim 8, characterized in that the polysaccharide particles are manufactured of starch by oxidizing, hydrolyzing, cross-linking, cationizing, grafting, etherifying or esterifying.

10. A product according to claim 9, characterized in that the polysaccharide particles consist of a starch ester that dissolves poorly in water.

11. A product according to claim 10, characterized in that the starch ester is starch acetate, its degree of substitution being 1.5 to 3.0, preferably about 2.0 to 3.0.

12. A product according to claim 9, characterized in that the polysaccharide particles comprise
spherical particles with a size of about 100 to 500 nanometres and an ISO brightness of more than 80, or
micro/nanoporous particles with a size of about 1 to 100 microns, containing pores with an average size of about 100 to 500 nanometres.

13. A product according to claim 8, characterized in that the polysaccharide-based particles comprise microcrystalline cellulose or an ether or ester derivative of cellulose.

14. A product according to claim 1, characterized in that 5 to 100% by weight of the filler of the base layer or the pigment of the coating layer (2) of the base layer consists of polysaccharide-based particles.

15. A product according to claim 14, characterized in that, in addition to the polysaccharide-based pigment particles, the coating layer contains mineral pigments, such as kaolin, calcium carbonate, talc, gypsum, or a mixture thereof.

16. A product according to claim 15, characterized in that the coating layer contains 5 to 50 weight fractions of polysaccharide-based particles and 50 to 95 weight fractions of mineral pigments.

17. A product according to claim 16, characterized in that the surface weight of the coating layer is about 5 to 50 g/m², preferably about 10 to 40 g/m² per side of the base layer.

18. A product according to claim 1, characterized in that the base layer is treated to at least partially plasticize the polysaccharide-based particles before spreading the polymer film on the surface of the base layer.

19. A product according to claim 1, characterized in that 0.1 to 10 g/m² of polysaccharide-based particles have been spread on the surface of the base layer or the coating layer covering the base layer.

20. A product according to claim 1, characterized in that the base layer is calendered and, possibly, corona-treated before the polymer film is spread on the surface of the base layer.

21. A product according to claim 1, characterized in that its final total weight is about 5 to 500 g/m², preferably about 50 to 450 g/m², especially preferably about 60 to 400 g/m².

22. A product according to claim 1, characterized in being suitable as packing material, wrapping or a moisture barrier.

23. A means of improving the adhesion between a substrate and a plastic film covering the same, characterized in that polysaccharide particles are provided on the interface between the substrate and the plastic film, the particles being able to improve the adhesion between the substrate and the plastic film.

24. A means according to claim 23, characterized in that starch-based pigments are used as the polysaccharide particles.

25. A method of manufacturing a paper or board product comprising a base layer (1) made of paper or board, a polymer film (3) being provided on at least one surface of the base layer, characterized in that
polysaccharide-based particles are incorporated into the surface of the base layer (1) facing the polymer film (3),
the coated base layer (1) is treated to at least partially plasticize the polysaccharide-based particles before spreading the polymer film (3) on the surface of the base layer (1), and
the polymer film (3) is applied on top of the surface.

26. A method according to claim 25, characterized in that a polysaccharide-based pigment is spread on the surface of the base layer by applying on top of the same at least one coating layer (2) that contains said pigment.

27. A method according to claim 25, characterized in that the polymer film (3) is applied on the surface of the coating layer by extrusion.

28. A method according to claim 26, characterized in that the coated paper or board track (1), which is coated with the polymer film, is fed through a nip (7) between a chill roll (5) and a press roll (6), whereby an extrusion-coated paper or board product (1′) is obtained.

29. A method according to claim 25, characterized in that 5 to 50 g/m², preferably about 10 to 40 g/m² of a coating layer (2) containing polysaccharide particles is spread on top of the base layer (1).

30. A method according to claim 25, characterized in that the base layer is calendered and optionally corona-treated before spreading the polymer film on the surface of the base layer.

31. A method according to claim 25, characterized in that the polysaccharide-based particles are starch or cellulose-based.

32. A method according to claim 25, characterized in that the base layer is provided, on both surfaces thereof, with a coating layer and a polymer film covering the same.

33. A method according to claim 25, characterized in that 0.1 to 10 g/m² of polysaccharide-based particles are incorporated onto the surface of the base layer.
